(19) United States
(12) Patent Application Publication
(10) Pub. No.: US 2020/0002590 A1
(43) Pub. Date: Jan. 2, 2020

(54) HEAT STORAGE PARTICLE, COMPOSITION FOR THERMOSTATIC DEVICE, AND THERMOSTATIC DEVICE

(71) Applicant: Murata Manufacturing Co., Ltd., Nagaokakyo-shi (JP)

(72) Inventors: Kou Tanaka, Nagaokakyo-shi (JP); Yuji Yokoyama, Nagaokakyo-shi (JP); Mitsugu Takada, Nagaokakyo-shi (JP); Ryo Teraura, Nagaokakyo-shi (JP); Mitsunari Imasaka, Nagaokakyo-shi (JP); Noboru Tanida, Nagaokakyo-shi (JP); Toshihiko Yamada, Nagaokakyo-shi (JP); Yoshihiro Iwasaki, Nagaokakyo-shi (JP)

(21) Appl. No.: 16/534,278

(22) Filed: Aug. 7, 2019

Related U.S. Application Data
(63) Continuation of application No. PCT/JP2018/028160, filed on Jul. 26, 2018.

(30) Foreign Application Priority Data
Jul. 29, 2017 (JP) 2017-147268

(51) Int. Cl. C09K 5/14; C09C 1/00; C08K 9/02; C08K 3/22; C08J 5/18; F28D 20/02

(52) U.S. Cl. CPC C09K 5/14; C09C 1/0006; C08K 9/02; C08K 3/22; C08K 2201/001; F28D 20/02; C01P 2004/80; C01P 2006/32; C08K 2003/2258; C08J 5/18

(57) ABSTRACT

A heat storage particle that includes a ceramic particle containing a vanadium oxide as a main component thereof, and a metal film covering the ceramic particle.

### CROSS REFERENCE TO RELATED APPLICATIONS

The present application is a continuation of International application No. PCT/JP2018/028160, filed Jul. 26, 2018, which claims priority to Japanese Patent Application No. 2017-147268, filed Jul. 29, 2017, the entire contents of each of which are incorporated herein by reference.

### FIELD OF THE INVENTION

The present invention relates to a heat storage particle, and more specifically relates to a heat storage particle utilizing latent heat accompanied with a solid-solid phase transition.

In addition, the present invention relates to a composition for a thermostatic device and a thermostatic device containing the heat storage particle of the present invention.

### BACKGROUND OF THE INVENTION

In recent years, energy savings have been demanded in the fields of houses, automobiles, and infrastructures. With such demands, in order to deal with industrial problems such as energy loss at the time of heat release, the utilization of heat storage materials has been attracting attention. Among heat storage materials, in particular, a heat storage material utilizing latent heat accompanied with a solid-solid phase transition (crystal structure phase transition, magnetic phase transition, etc.) is a material having a high thermal conductivity, high heat responsibility, a small temperature width between the endothermic temperature and the exothermic temperature, a stable phase transition temperature, and capable of repeated use. Applications of such heat storage materials to various fields have been increasingly studied.

Incidentally, focusing attention on the function to keep the ambient temperature constant, a heat storage material can be expressed as a thermostatic material. In addition, a cooling material temporarily absorbs excessive heat to decrease the temperature, and can be regarded as one mode of a thermostatic material. Similarly, a heat storage device can be configured as a thermostatic device. In addition, a cooling device can be regarded as one mode of a thermostatic device.

A heat storage material utilizing latent heat accompanied with a solid-solid phase transition has been disclosed in Patent Document 1 (Japanese Patent Application Laid-Open No. 2010-163510). The heat storage material disclosed in Patent Document 1 utilizes latent heat accompanied with the solid-solid phase transition of a vanadium oxide, for example. Specifically, when the ambient temperature rises and becomes equal to or higher than the first phase transition temperature (endothermic temperature), the heat storage material starts heat absorption to store heat. Conversely, when the ambient temperature falls and becomes equal to or lower than the second phase transition temperature (exothermic temperature), the heat storage material starts heat generation to release heat.

However, the heat storage material disclosed in Patent Document 1 has been problematic in that when placed in a high-humidity environment, the heat storage properties gradually deteriorate. That is, there has been a problem in that because a vanadium oxide has hydration ability, when moisture penetrates into vanadium oxide crystals, the vanadium oxide turns into a hydrate, resulting in the deterioration of heat storage properties.

A heat storage material for solving this problem has been disclosed in Patent Document 2 (Japanese Patent Application Laid-Open No. 2017-65984). In the heat storage material disclosed in Patent Document 2, a surface of a ceramic particle formed of a vanadium oxide is covered with a film of titanium oxide having a rutile structure. That is, the heat storage material disclosed in Patent Document 2 is configured such that the ingress of moisture into the ceramic particle is suppressed by the titanium oxide film so as to prevent the heat storage properties from deterioration even when placed in a high-humidity environment.

Patent Document 1: Japanese Patent Application Laid-Open No. 2010-163510

Patent Document 2: Japanese Patent Application Laid-Open No. 2017-65984

### SUMMARY OF THE INVENTION

In the heat storage material disclosed in Patent Document 2, a surface of a ceramic particle formed of a vanadium oxide is covered with a film of titanium oxide, whereby the deterioration of heat storage properties in a high-humidity environment has been ameliorated. However, there has been a problem in that because the thermal conductivity of titanium oxide is low, the heat responsibility deteriorates.

Specifically, the heat storage material disclosed in Patent Document 2 has been problematic in that even when the ambient temperature rises and becomes equal to or higher than the first phase transition temperature (endothermic temperature), heat absorption is not started immediately but is started after a lapse of a predetermined period of time, and further the amount of heat absorption per unit time is small; as a result, it takes time to complete heat storage. In addition, the heat storage material disclosed in Patent Document 2 has been problematic in that even when the ambient temperature falls and becomes equal to or lower than the second phase transition temperature (exothermic temperature), heat generation is not started immediately but is started after a lapse of a predetermined period of time, and further the amount of heat generation per unit time is small; as a result, it takes time to complete heat release.

Accordingly, there has been a problem in that the heat storage material disclosed in Patent Document 2 cannot be used for applications where high heat responsibility is required, and its applications are limited.

The present invention has been accomplished to solve the above problems of related art, and, as a means of resolution, the heat storage particle of the present invention include a ceramic particle containing a vanadium oxide as a main component thereof, and a metal film covering the ceramic particle.

It is preferable that the metal film contains Ni as a main component. In this case, the ingress of moisture into the ceramic particles is suppressed by the metal film containing Ni as a main component. As a result, heat storage particles whose heat storage properties are unlikely to deteriorate even when placed in a high-humidity environment can be obtained. In addition, a metal film containing Ni as a main component has higher thermal conductivity as compared with the case of titanium oxide, etc. As a result, heat storage particle having excellent heat responsibility can be obtained.

It is preferable that the metal film has a thickness of 5 nm to 5 μm. This is because when the thickness of the metal film is less than 5 nm, the moisture resistance may be insufficient. This is also because when the thickness of the metal film is more than 5 μm, the film may be influenced by stress due to the difference in thermal expansion coefficient from the ceramic particle.

It is also preferable that the vanadium oxide is at least one vanadium oxide represented by V₁₋ₓMₓO₂, wherein M is W, Ta, Mo, or Nb, and X is 0 to 0.05. In this case (excluding the case where M is 0), both the first phase transition temperature (endothermic temperature) and the second phase transition temperature (exothermic temperature) can be shifted to a lower-temperature side. As a result, a heat storage device that starts heat absorption (heat storage) at a lower temperature can be produced.

In the above case, it is more preferable that X is 0 to 0.03. This is because although the presence of M may cause the deterioration of heat storage properties, when X is 0.03 or less, its influence can be suppressed to be small.

By adding the heat storage particle described above to a resin, a composition for a thermostatic device can be obtained. Incidentally, a thermostatic device refers to a device that absorbs heat in the case where the ambient temperature rises so as to suppress the rise of temperature, while releases heat in the case where the ambient temperature falls so as to suppress the fall of temperature, thereby keeping the ambient temperature constant. It can be said that a cooling device is one mode of a thermostatic device.

In the composition for a thermostatic device, it is preferable that a content of the heat storage particle in the resin is 2 vol % to 60 vol %. This is because when the content of the heat storage particle in the resin is less than 2 vol %, a sufficient amount of heat storage (the amount of heat absorption and the amount of heat generation) cannot be ensured. This is also because when the content of the heat storage particle in the resin is more than 60 vol %, sufficient resin kneading strength cannot be obtained.

Using the composition for a thermostatic device described above, a thermostatic device (including a cooling device) can be produced. In this case, it is also preferable that the thermostatic device is formed in a sheet shape. This is because in the case where the thermostatic device is formed in a sheet shape, the surface area increases, and the efficiency of heat absorption or heat generation improves. For example, when the thermostatic device formed as a sheet is directly attached to an electronic part in an electronic device, the rise in temperature due to heat generation of the electronic part can be efficiently suppressed.

In the heat storage particle of the present invention, because a ceramic particle containing a vanadium oxide as a main component thereof is covered with a metal film, the ingress of moisture into the ceramic particle is suppressed, and the heat storage properties are unlikely to deteriorate even when placed in a high-humidity environment. In addition, because the metal film covering the ceramic particle containing a vanadium oxide as a main component thereof has high thermal conductivity, the heat storage particle of the present invention has excellent heat responsibility.

In addition, in the composition for a thermostatic device and the thermostatic device of the present invention, because the heat storage particle of the present invention is used, the heat storage properties are unlikely to deteriorate even when placed in a high-humidity environment. In addition, because the heat storage particle of the present invention are used, the composition for a thermostatic device and the thermostatic device of the present invention have excellent heat responsibility.

### BRIEF EXPLANATION OF THE DRAWINGS

FIG. 1 is a schematic diagram (cross-sectional view) showing a heat storage particle 100 according to an embodiment.

FIG. 2 is a graph showing the amount of heat storage at the phase transition points of a vanadium oxide.

FIG. 3 is a graph showing the results of a moisture resistance test.

### DETAILED DESCRIPTION OF THE INVENTION

Hereinafter, embodiments of the present invention will be described with reference to the drawings. Incidentally, the embodiments exemplarily show modes for carrying out the present invention, and the present invention is not limited to the contents of the embodiments.

(Heat Storage Particle)

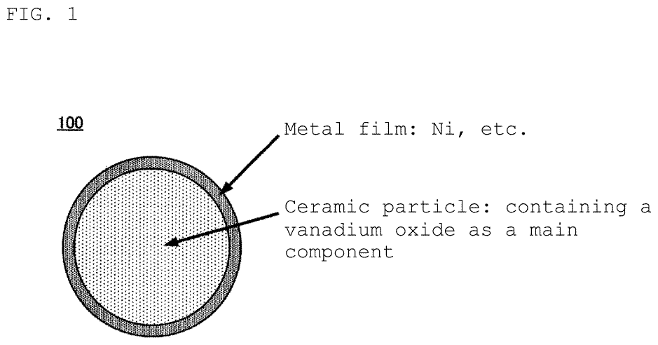

FIG. 1 shows a schematic diagram of a heat storage particle 100 according to an embodiment. Note that FIG. 1 shows a cross-section of the heat storage particle 100.

The heat storage particle 100 includes a ceramic particle containing a vanadium oxide as a main component thereof.

A vanadium oxide absorbs or generates heat accompanied with a solid-solid phase transition, such as a crystal structure phase transition or a magnetic phase transition. Specifically, when the ambient temperature rises and becomes equal to or higher than the first phase transition temperature (endothermic temperature), a phase transition is started, and also heat absorption is started. Conversely, when the ambient temperature falls and becomes equal to or lower than the second phase transition temperature (exothermic temperature), a phase transition is started, and also heat generation is started. Using such properties, a vanadium-containing oxide can be utilized as a heat storage material.

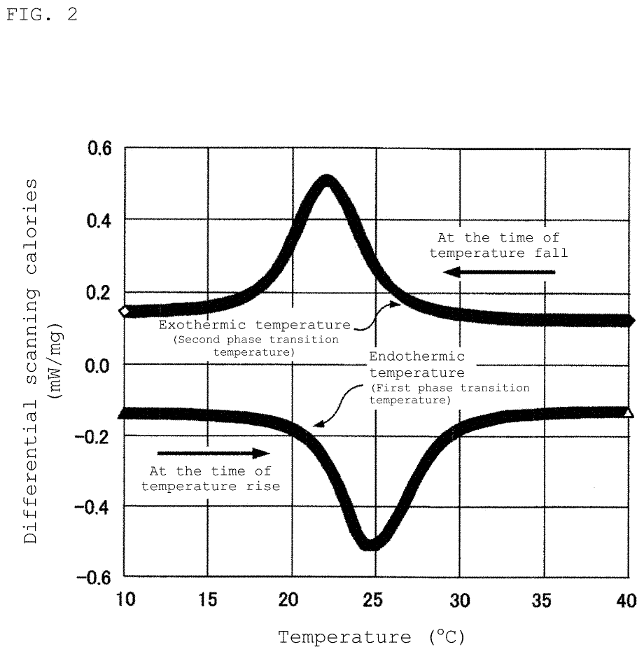

FIG. 2 shows the amount of heat storage at the phase transition points of a vanadium oxide. Note that FIG. 2 shows an example using V_{0.997}W_{0.023}O₂ as a vanadium oxide. The amount of heat storage is measured by differential scanning calorimetry using a differential scanning calorimeter.

As described above, the ceramic particle of the heat storage particle 100 contains a vanadium oxide as a main component. In this application, “main component” means a component contained therein in a proportion of 60 mass % or more, particularly 80 mass % or more, preferably 90 mass % or more, more preferably 95 mass % or more, and still more preferably 98 mass % or more, and for example, a component contained therein in a proportion of 98.0 to 99.8 mass %, or substantially 100%, is referred to. Incidentally, the kind of components other than the vanadium oxide contained in the ceramic particle of the heat storage particle 100 is not limited. There may be inevitably incorporated impurities or intentionally added additives.

Because of the properties of a vanadium oxide described above, the ceramic particle of the heat storage particle 100 has a heat storage function.

Typical examples of the vanadium oxide serving as a main component of the ceramic particle are vanadium oxides, typically vanadium dioxide (VO₂).

Vanadium oxides containing V and M (here, M is at least one member selected from W, Ta, Mo, and Nb) are preferred examples of the vanadium oxide serving as a main component of the ceramic particle. Incidentally, it is preferable that when the total of V and M is 100 molar parts, the M content in molar parts is 0 molar parts to 5 molar parts.

The M content in molar parts is specified to be 5 molar parts or less for the purpose of suppressing the deterioration of heat storage properties. Incidentally, in order to suppress the deterioration of heat storage properties to be small, it is more preferable that the M content in molar parts is 3 molar parts or less.

In addition, as another preferred example of the vanadium oxide, at least one vanadium oxide represented by the formula: V₁₋ₓMₓO₂ (wherein M is W, Ta, Mo, or Nb, and X is 0 to 0.05) can be utilized.

This vanadium oxide is obtained by partially substituting V in VO₂ with at least one member selected from W, Ta, Mo, and Nb. As a result of this substitution, in this vanadium oxide, the first phase transition temperature (endothermic temperature) and the second phase transition temperature (exothermic temperature) are shifted to a lower-temperature side than the first phase transition temperature (endothermic temperature) and the second phase transition temperature (exothermic temperature) of VO₂, respectively.

In addition, as another preferred example of the vanadium oxide, at least one vanadium oxide represented by the formula: V₁₋ₓWₓO₂ (wherein X is 0 to 0.01) can be utilized.

In addition, as another preferred example of the vanadium oxide, a vanadium oxide in the form of a complex oxide containing A (here, A is Li or Na) and V, wherein the A content in molar parts per 100 molar parts of V is 50 to 110 molar parts, can be utilized. In this vanadium oxide, the first phase transition temperature (endothermic temperature) and the second phase transition temperature (exothermic temperature) are shifted to a higher-temperature side than the first phase transition temperature (endothermic temperature) and the second phase transition temperature (exothermic temperature) of VO₂, respectively.

The A content in molar parts is specified to be 50 molar parts or more for the purpose of developing the effect of shifting the first phase transition temperature (endothermic temperature) and the second phase transition temperature (exothermic temperature) to a higher-temperature side. In addition, the A content in molar parts is specified to be 110 molar parts or less for the purpose of suppressing the deterioration of the heat storage function near a phase transition temperature. This is because when the phase transition temperature becomes too high, the oxidation of the vanadium oxide itself progresses, possibly making it difficult to develop the heat storage function. Incidentally, the A content in molar parts is more preferably 70 molar parts to 110 molar parts, and still more preferably 70 molar parts to 98 molar parts.

In addition, as still another preferred example of the vanadium oxide, a complex oxide containing A (here, A is Li or Na), V, and a transition metal (e.g., at least one member selected from titanium, cobalt, iron, and nickel), wherein the molar ratio of V to the transition metal is within a range of 995:5 to 850:150, and the molar ratio of the total of vanadium and the transition metal to A is within a range of 100:70 to 100:110, can be utilized.

In addition, as still another preferred example of the vanadium oxide, at least one vanadium oxide represented by the formula: A_{y}V_{1-z}M^{a}_{z}O₂ (wherein A is Li or Na, M^{a} is a transition metal; y is 0.5 to 1.1, y is preferably 0.7 to 1.1, and z is 0 to 0.15) can be utilized.

In the above formula, it is preferable that A is Li. In addition, it is preferable that M^{a} is at least one metal selected from titanium, cobalt, iron, and nickel.

In addition, in the above formula, it is preferable that y and z satisfy either of the following (a) and (b):

(a) 0.70≤y≤0.98, and z=0,

(b) 0.70≤y≤1.1, and 0.005≤z≤0.15.

In addition, as still another preferred example of the vanadium oxide, a vanadium oxide doped with Ti or a vanadium oxide further doped with an additional atom selected from the group consisting of W, Ta, Mo, and Nb, wherein in the case where the additional atom is W, the additional atom content in molar parts per 100 molar parts of the total of V, Ti, and the additional atom is more than 0 molar parts and 5 molar parts or less, while in the case where the additional atom is Ta, Mo, or Nb, the additional atom content in molar parts per 100 molar parts of the total of V, Ti, and the additional atom is more than 0 molar parts and 15 molar parts or less, and the Ti content in molar parts per 100 molar parts of the total of V, Ti, and the additional atom is 2 molar parts to 30 molar parts, can be utilized. When this vanadium oxide is used, ceramic particles having improved moisture resistance can be obtained.

In the vanadium oxide doped with Ti described above, it is more preferable that the titanium content in molar parts per 100 molar parts of the total of Ti and the additional atom is 5 molar parts to 10 molar parts.

Incidentally, in this application, “vanadium oxide doped with Ti” means a vanadium oxide showing a corresponding crystal structure as a result of X-ray structural analysis (typically, powder X-ray diffractometry is used). In addition, as used herein, “vanadium oxide further doped with an additional atom” is a vanadium oxide doped with Ti and also an additional atom, and means a vanadium oxide showing a corresponding crystal structure as a result of X-ray structural analysis.

In addition, as still another preferred example of the vanadium oxide, a vanadium oxide represented by the formula: V_{1-x-y}TiₓM_{y}O₂ (wherein M is W, Ta, Mo, or Nb, X is 0.02 to 0.30, and y is 0 or more, with the proviso that when M is W, y is 0.05 or less, and when M is Ta, Mo, or Nb, y is 0.15 or less) can be utilized. When this vanadium oxide is used, a ceramic particle having improved moisture resistance can be obtained.

In the above formula, it is more preferable that x is 0.05 to 0.10.

Preferred examples of the vanadium oxide serving as a main component of the ceramic particles have been shown above. However, the first phase transition temperature (endothermic temperature) and the second phase transition temperature (exothermic temperature) of each can be adjusted by doping with other atoms or by adjusting the added amount of such an atom.

The first phase transition temperature (endothermic temperature) and the second phase transition temperature (exothermic temperature) of a vanadium oxide are suitably selected according to the thermostatic device (cooling device) produced using the heat storage particle 100. For example, in the case where the thermostatic (cooling) target is a human body, the first phase transition temperature (endothermic temperature) is preferably 15° C. to 60° C., and more preferably 25° C. to 40° C.

It is preferable that the vanadium oxide has an initial latent heat amount of 10 J/g or more. The initial amount of latent heat is more preferably 20 J/g or more, and the initial amount of latent heat is still more preferably 50 J/g or more. This is because when the amount of latent heat is large, a greater thermostatic effect (cooling effect) can be exerted with a smaller volume, which is advantageous in reducing the size of the thermostatic device (cooling device). Here, “latent heat” is the total amount of thermal energy required for the phase change of a substance. In this application, the amount of heat absorption or heat generation accompanying a solid-solid phase transition, such as an electrical, magnetic, or structural phase transition, is referred to.

The average particle size (D50: in a cumulative curve formed by determining a volume-based particle size distribution and taking the total volume as 100%, the particle size at a cumulative value of 50%) of the ceramic particle containing a vanadium oxide as a main component is not particularly limited, but is, for example, 0.01 μm or more and several hundred micrometers or less, specifically 0.1 μm to 50 μm, and typically 0.1 μm to 2 μm, and may be, for example, 0.1 μm to 0.6 μm. The average particle size can be measured using a laser diffraction/scattering particle size distribution analyzer or an electronic scanning microscope. In addition, the average particle size is preferably 0.1 μm or more in terms of the ease of handling and the ease of covering with a metallic film, and is preferably 50 μm or less in terms of achieving higher formation density.

The coarse particle size (D99: in a cumulative curve formed by determining a volume-based particle size distribution and taking the total volume as 100%, the particle size at a cumulative value of 99%) of the ceramic particles containing a vanadium oxide as a main component is not particularly limited, but is, for example, 0.01 μm to 100 μm, specifically 0.05 μm to 50 μm, and typically 0.1 μm to 2 μm, and may be, for example, 10 μm to 80 μm, or 30 μm to 50 μm. The coarse particle size can be measured using a laser diffraction/scattering particle size distribution analyzer.

Table 1 shows an example of the particle size distribution of ceramic particle of the heat storage particle 100. The values are each a value after grinding by EKINEN dispersion.

TABLE 1

| D10 | D50 | D90 | D99 |
|---|---|---|---|
| 2.5 μm | 5.0 μm | 8.8 μm | 13.6 μm |

In the heat storage particle 100 according to this embodiment, as shown in FIG. 1, ceramic particle are covered with a metal film. The metal film is formed to suppress the ingress of moisture into the ceramic particle. In the heat storage particle 100, because of the formation of the metal film, the heat storage properties are unlikely to deteriorate even when placed in a high-humidity environment.

The metal film contains Ni as a main component, for example. However, components of the metal film are arbitrary. For example, the main component may be a transition metal element such as Ti, Zr, Nb, Ta, V, Au, Ag, or Cu, an alkaline earth metal such as Ca, Mg, or Sr, a base metal such as Al or Sn, a semi-metal such as Si, or the like. However, a trace amount of oxide may be present.

The method for forming a metal film is arbitrary. For example, the metal film may be formed by sputtering, chemical vapor deposition (CVD), a sol-gel method, plating, or the like.

In the case where the metal film is formed by sputtering, it is preferable that the method is so-called barrel sputtering, in which ceramic particles containing a vanadium oxide as a main component are placed in a barrel, and a film is formed while rotating the barrel.

The thickness of the metal film is arbitrary. However, it is preferable that the metal film has a thickness of 5 nm to 5 μm. This is because when the thickness of the metal film is less than 5 nm, the moisture resistance may be insufficient. This is also because when the thickness of the metal film is more than 5 μm, the film may be influenced by stress due to the difference in thermal expansion coefficient from the ceramic particles.

Incidentally, the thickness of the metal film that coats ceramic particles is measured by the following method. First, an appropriate amount of heat storage particles coated with a metal film are mixed with an uncured resin and sufficiently diffused. Next, the resin is cured. Next, the cured resin is polished to expose arbitrary cross-sections, and an image thereof is taken by TEM (transmission electron microscope)-EDX. In the observation, in some cases, images are taken by SEM (scanning electron microscope)-EDX, ATM (atomic microscope), or the like. Next, from the taken image, a square region in which 30 or more and less than 40 heat storage particles are present is arbitrarily selected, and the selected region is defined as a measurement region. Next, from the 30 or more and less than 40 heat storage particles present in the measurement region, 15 heat storage particles with the largest cross-sectional areas are selected and specified as the measurement-target heat storage particles. Next, in each measurement-target heat storage particle, a portion where the covering metal film has a maximum thickness is found, the thickness thereof is measured, and the measured thickness is defined as the thickness of the metal film of the target heat storage particle. Next, the average thickness of the metal films of the 15 measurement-target heat storage particles is calculated, and the measured average is defined as the thickness of the metal film of the heat storage particle (heat storage particle mixed with an uncured resin).

In addition, in the above measurement method, the reason why 15 heat storage particles with the largest cross-sectional areas are selected from 30 or more and less than 40 heat storage particles present in the measurement region and used as the measurement-target heat storage particles is that the thickness of a metal film formed as close as possible to the maximum size portion of ceramic particle is to be measured.

In the heat storage particle 100, the metal film covering the ceramic particles has higher thermal conductivity as compared with a titanium oxide film and the like. Therefore, the heat storage particle 100 have excellent heat responsibility.

For example, conventional heat storage particle having ceramic particles covered with a titanium oxide film have been problematic in that even when the ambient temperature rises and becomes equal to or higher than the first phase transition temperature (endothermic temperature), heat absorption is not started immediately but is started after a lapse of a predetermined period of time, and further the amount of heat absorption per unit time is small; as a result, it takes time to complete heat storage. Similarly, conventional heat storage particle having ceramic particle covered with a titanium oxide film have been problematic in that even when the ambient temperature falls and becomes equal to or lower than the second phase transition temperature (exothermic temperature), heat generation is not started immediately but is started after a lapse of a predetermined period of time, and further the amount of heat generation per unit time is small; as a result, it takes time to complete heat release.

Meanwhile, in the heat storage particle 100, because the ceramic particle is covered with a metal film having high thermal conductivity, the heat responsibility is excellent. Specifically, in the heat storage particle 100, heat absorption is immediately started when the ambient temperature becomes equal to or higher than the first phase transition temperature (endothermic temperature), and also the heat storage is completed within a short period of time. Similarly, in the heat storage particle 100, heat generation is immediately started when the ambient temperature becomes equal to or lower than the second phase transition temperature (exothermic temperature), and also the heat release is completed within a short period of time.

(Composition for Thermostatic Device)

The composition for a thermostatic device (composition for a cooling device) of this embodiment is formed from a resin containing the heat storage particles 100.

The kind of resin is arbitrary and may be a thermosetting resin or a thermoplastic resin.

Examples of usable thermosetting resins include a urethane resin, an epoxy resin, a polyimide resin, a silicone resin, a fluororesin, a liquid crystal polymer resin, and a polyphenyl sulfide resin. These resins may be used alone, and it is also possible to use a mixture of two or more kinds.

In the case of a thermosetting resin, a curing agent is added to the resin as necessary. The kind of curing agent is arbitrary, and polyamine, imidazole, or the like is added, for example.

Examples of usable thermoplastic resins include polyethylene, polypropylene, polyvinyl chloride, polystyrene, polyvinyl acetate, an acrylic resin, nylon, and polyester. These resins may be used alone, and it is also possible to use a mixture of two or more kinds.

The content of the heat storage particle in the composition for a thermostatic device is arbitrary, but is preferably 2 vol % to 60 vol %. This is because when the content of the heat storage particle is less than 2 vol %, a sufficient amount of heat storage (the amount of heat absorption and the amount of heat generation) cannot be ensured. This is also because when the content of the heat storage particle is more than 60 vol %, sufficient resin kneading strength cannot be obtained. In terms of securing a sufficient amount of heat storage, the content of the heat storage particle in the composition for a thermostatic device is more preferably 5 vol % or more, and still more preferably 10 vol % or more. In addition, in terms of obtaining sufficient resin kneading strength, the content is more preferably 50 vol % or less.

The resin may further contain dispersants, plasticizers, binders, glass, and the like as additives. The kind and added amount of additives are suitably selected according to the properties and shape required for the thermostatic device, production method, and the like.

(Thermostatic Device)

The thermostatic device (cooling device) of this embodiment is produced using the composition for a thermostatic device (composition for a cooling device) of this embodiment described above.

The production method for the thermostatic device is arbitrary, and the device may be produced by a method commonly used in the field of resin-containing devices. However, an electronic device may be produced by a special method. For example, it is possible that the composition for a thermostatic device is previously formed into a paste, applied to a necessary part, and solidified (cured) to give a thermostatic device.

The shape of the thermostatic device is arbitrary, and may be formed in a sheet shape, for example. In the case where the thermostatic device is formed in a sheet shape, the surface area increases, whereby the efficiency of heat absorption or heat generation improves. That is, the amount of heat absorption or the amount of heat generation per unit time can be increased.

For example, when the thermostatic device formed as a sheet is directly attached to an electronic part in an electronic device, the rise in temperature due to heat generation of the electronic part can be efficiently suppressed.

### Example 1

Three kinds of examples were produced using different covering metals. In Example 1-1, ceramic particles were covered with Ni. In Example 1-2, ceramic particles were covered with Ti. In Example 1-3, ceramic particles were covered with Cu.

In addition, comparative examples were produced for comparison. In Comparative Example 1-1, ceramic particles were covered with TiO₂. In Comparative Example 1-2, ceramic particles were covered with SiO₂. In Comparative Example 1-3, ceramic particles were not covered.

The production method in the examples and comparative examples will be described below.

(Production of Ceramic Particles Containing Vanadium Oxide as Main Component)

Vanadium trioxide (V₂O₃), vanadium pentoxide (V₂O₅), and tungsten oxide as ceramic raw materials were weighed to V:W:0=0.985:0.015:2 (molar ratio) and dry-blended. Next, in a nitrogen/hydrogen/water atmosphere, the mixture was heat-treated at 950° C. for 4 hours to give ceramic particles of V_{0.985}W_{0.015}O₂. The particle size of the obtained ceramic particles was measured using a laser diffraction analyzer (microtrak method, scattering method). As a result, D50 was 40 μm.

(Formation of Film)

The obtained ceramic particles were placed in a chamber filled with Ar gas to a chamber pressure of 0.5 Pa to 1.0 Pa, and the gas was plasmatized by discharge at a predetermined electric power, thereby performing sputtering film formation. At this time, the ceramic particles were stirred by the drive mechanism of a barrel and moved in such a manner that new ceramic particle surfaces were constantly exposed to the sputtering particles. By such barrel sputtering, the particles were covered with a metal or an oxide having a thickness of about 20 nm, giving an example sample or a comparative example sample. However, in Comparative Example 1-3, no film was formed, and the ceramic particles described above were directly used as a comparative example sample.

(Moisture Resistance Test)

With respect to each of the heat storage particles of examples and the heat storage particles of comparative examples, the initial amount of heat storage was measured by a DSC (differential scanning calorimetry) method. Specifically, in a nitrogen atmosphere, heating was performed from 0° C. to 100° C. at a temperature rise rate of 10K/min, followed by sweeping to 0° C., and the amount of heat absorption at the time of temperature rise was defined as the amount of heat storage.

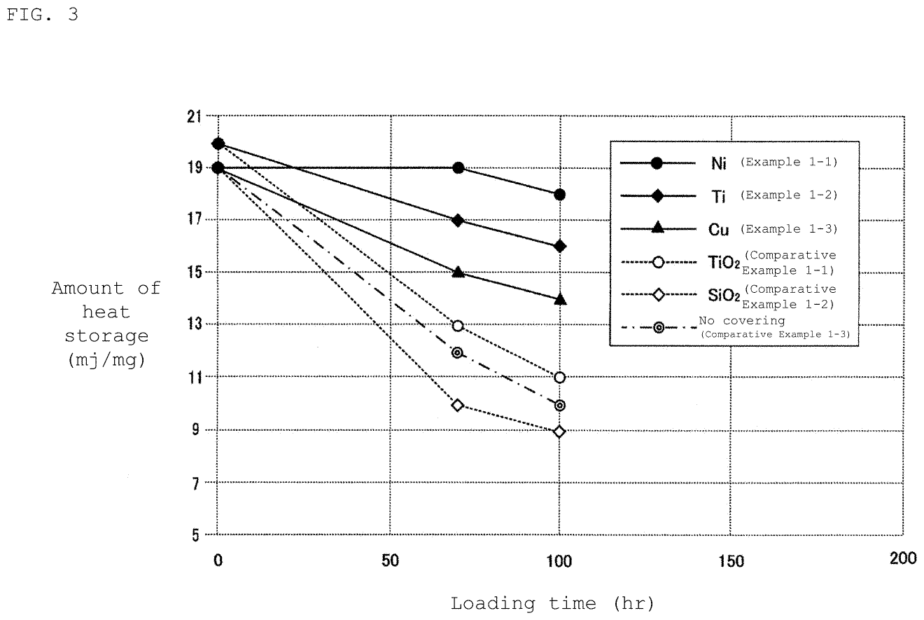

Next, the heat storage particles of examples and the heat storage particles of comparative examples were each allowed to stand in an environment of 85° C. and a relative humidity of 85%. In Example 1-1 and Comparative Example 1-3, the particles were allowed to stand for the following three periods of time: 70 hours, 100 hours, and 500 hours. In Example 1-2, Example 1-3, Comparative Example 1-1, and Comparative Example 1-2, the particles were allowed to stand for the following two periods of time: 70 hours and 100 hours. Subsequently, the amount of heat storage in each case was measured again. The measurement results are shown in Table 2, Table 3, and FIG. 3.

TABLE 2

| | | | Amount of heat storage (mJ/mg) | |
|---|---|---|---|---|
| | | | | Comparative |
| | | | Example 1-1 | Example 1-3 |
| | | | (Ni film) | (No film) |
| No load | Initial amount of | | 19 | 19 |
| | heat storage | | | |
| Loading | Temperature: | 70 hr | 19 | 12 |
| | 85° C. | 100 hr | 18 | 10 |
| | Humidity: | 500 hr | 16 | 0 |
| | 85% | | | |

TABLE 3

| | | | Amount of heat storage (mJ/mg) | | | Rate of decrease |
|---|---|---|---|---|---|---|
| | | Thickness | Initial amount | | | in the amount of |
| | Kind of | of film | of heat | | | heat storage after |
| | film | (nm) | storage | 70 hr | 100 hr | a lapse of 100 hr |
| Example 1-1 | Ni | 20 | 19 | 19 | 18 | 5 |
| Example 1-2 | Ti | 19 | 20 | 17 | 16 | 20 |
| Example 1-3 | Cu | 23 | 19 | 15 | 14 | 26 |
| Comparative | TiO₂ | 18 | 20 | 13 | 11 | 45 |
| Example 1-1 | | | | | | |
| Comparative | SiO₂ | 21 | 19 | 10 | 9 | 53 |
| Example 1-2 | | | | | | |
| Comparative | Monitor | No film | 19 | 12 | 10 | 47 |
| Example 1-3 | | | | | | |

As can be seen from Table 2, Table 3, and FIG. 3, in Examples 1-1, 1-2, and 1-3, even after a lapse of 100 hours, the amount of heat storage decreased by only 26% maximum. Among them, in Example 1-1 where the particles were covered with Ni, the decrease in the amount of heat storage was small, and even after a lapse of 70 hours and after a lapse of 100 hours, the amount of heat storage decreased by only about 5%.

Meanwhile, in Comparative Examples 1-1 and 1-2 where the particles were covered with an oxide and in Comparative Example 1-3 where the particles were not covered, the amount of heat storage significantly decreased with the lapse of time. For example, in Comparative Example 1-2 where the particles were covered with SiO₂, after a lapse of 100 hours, the amount of heat storage decreased by 53%.

As described above, the heat storage particles of the examples having ceramic particles covered with a metal film had high moisture resistance, and the amount of heat storage did not significantly decrease even when placed in a high-humidity environment for a long period of time. Meanwhile, in all the comparative examples where the particles were covered with an oxide and the comparative example where the particles were not covered, the amount of heat storage significantly decreased with time. From above, it was confirmed that the heat storage particle of the present invention having ceramic particle covered with a metal film has high moisture resistance. In addition, it was confirmed that with respect to the kind of metal in the case of covering with a metal film, Ni is particularly excellent as compared with Ti or Cu.

### Example 2

Three kinds of examples were produced changing the thickness of the covering metal. In Example 2-1, the thickness of Ni was set at 40 nm. In Example 2-2, the thickness of Ni was set at 195 nm. In Example 2-3, the thickness of Cu was set at 40 nm. Incidentally, as ceramic particle, the same particle as in Example 1 was used.

A moisture resistance test was performed by the same method as in Example 1. The results of the moisture resistance test are shown in Table 4.

TABLE 4

| | | | Amount of heat storage | | | |
|---|---|---|---|---|---|---|
| | | | (mJ/mg) | | | |
| | | | Initial | | | Rate of decrease |
| | | Thickness | amount | | | in the amount of |
| | Kind of | of film | of heat | | | heat storage after |
| | film | (nm) | storage | 70 hr | 100 hr | a lapse of 100 hr |
| Example | Ni | 40 | 19 | 19 | 19 | 0 |
| 2-1 | | | | | | |
| Example | Ni | 195 | 19 | 19 | 19 | 0 |
| 2-2 | | | | | | |
| Example | Cu | 40 | 19 | 17 | 16 | 16 |
| 2-3 | | | | | | |

As can be seen from Table 4, in Example 2-1 and Example 2-2, no decrease in the amount of heat storage was seen. That is, as a result of covering with Ni having a thickness of 40 nm or more, no decrease in the amount of heat storage was seen. Meanwhile, in Example 2-3, the amount of heat storage decreased. In the case of covering with 40-nm Cu, although the decrease in the amount of heat storage was suppressed as compared with Example 1-3 of covering with 23-nm Cu, a decrease in the amount of heat storage was seen.

As described above, it was confirmed that with respect to the kind of metal in the case of covering with a metal film, Ni is particularly excellent as compared with Cu.

In addition, from Table 3 and Table 4, it was confirmed that when the thickness of the metal film is 20 nm to 195 nm, the amount of heat storage does not significantly decrease.

1. A heat storage particle comprising:
a ceramic particle containing a vanadium oxide as a main component thereof; and
a metal film covering the ceramic particle.

2. The heat storage particle according to claim 1, wherein the metal film contains Ni as a main component.

3. The heat storage particle according to claim 2, wherein the metal film has a thickness of 5 nm to 5 μm.

4. The heat storage particle according to claim 1, wherein the metal film has a thickness of 5 nm to 5 μm.

5. The heat storage particle according to claim 1, wherein the vanadium oxide is at least one vanadium oxide represented by V₁₋ₓMₓO₂,
wherein
M is W, Ta, Mo, or Nb, and
X is 0 to 0.05.

6. The heat storage particle according to claim 5, wherein X is 0 to 0.03.

7. The heat storage particle according to claim 5, wherein X is 0 to 0.01.

8. The heat storage particle according to claim 1, wherein the vanadium oxide contains at least one of W, Ta, Mo, or Nb.

9. The heat storage particle according to claim 1, wherein the vanadium oxide contains Li or Na.

10. The heat storage particle according to claim 9, wherein a content of the Li or Na is 50 to 110 molar parts per 100 molar parts of the vanadium.

11. The heat storage particle according to claim 9, wherein the vanadium oxide further contains a transition metal.

12. The heat storage particle according to claim 11, wherein the transition metal is at least one of titanium, cobalt, iron, and nickel.

13. The heat storage particle according to claim 11, wherein a molar ratio of the vanadium to the transition metal is within a range of 995:5 to 850:150.

14. The heat storage particle according to claim 11, wherein a molar ratio of a total of the vanadium and the transition metal to the Li or Na is within a range of 100:70 to 100:110.

15. The heat storage particle according to claim 1, wherein the vanadium oxide is at least one vanadium oxide represented by A_{y}V_{1-z}M^{a}_{z}O₂,
wherein
A is Li or Na,
M^{a} is a transition metal,
y is 0.5 to 1.1, and
z is 0 to 0.15.

16. The heat storage particle according to claim 1, wherein the vanadium oxide is at least one vanadium oxide represented by V_{1-x-y}TiₓM_{y}O₂,
wherein
M is W, Ta, Mo, or Nb,
x is 0.02 to 0.30, and
y is 0 or more.

17. A composition for a thermostatic device, the composition comprising:
a resin; and
the heat storage particle according to claim 1 contained in the resin.

18. The composition for a thermostatic device according to claim 7, wherein a content of the heat storage particle in the resin is 2 vol % to 60 vol %.

19. A thermostatic device containing a cured product of the composition for a thermostatic device according to claim 17.

20. The thermostatic device according to claim 19, wherein the thermostatic device has a sheet shape.
